(19) United States
(12) Patent Application Publication
(10) Pub. No.: US 2026/0048984 A1
(43) Pub. Date: Feb. 19, 2026

(54) SYSTEMS AND METHODS FOR ACCELERATING PRODUCTION OF HYDROGEN FROM SERPENTINIZATION OF MAFIC OR ULTRAMAFIC ROCK

(71) Applicant: Anning Corporation, Houston, TX (US)

(72) Inventors: Sophie Clare Broun, Houston, TX (US); Andrew Duffy, North Fremantle, Perth (AU)

(73) Assignee: Anning Corporation, Houston, TX (US)

(21) Appl. No.: 19/302,769

(22) Filed: Aug. 18, 2025

Related U.S. Application Data
(60) Provisional application No. 63/684,825, filed on Aug. 19, 2024.

(51) Int. Cl. C01B 3/06; C01G 49/06; E21B 43/241

(52) U.S. Cl. CPC C01B 3/061; C01G 49/06; E21B 43/241

(57) ABSTRACT

Systems and methods for generating hydrogen through serpentinization of iron-bearing rock, including mafic rock, ultramafic rock and banded iron formations is presented herein. The systems and methods use geothermally-heated and/or surface-heated fluid circulating through one or more fluidically-communicative wellbores to accelerate the production of hydrogen. A geothermal-injector wellbore is formed in a geothermal rock layer, and is communicative with a separate geothermal-collection wellbore, also formed in the geothermal layer. Fluid is pumped through the geothermal-injector wellbore, geothermally heated, collected by the geothermal-collection wellbore, and injected into a targeted rock layer that includes iron-bearing rock. The heated fluid increases the rate of hydrogen production though serpentinization of the rock, which is then collected through a separate producer wellbore. In some cases, a serpentinization-injector wellbore is used to circulate surface-heated and/or chemically-treated fluid to the targeted rock layer to accelerate hydrogen production.

### CLAIM OF PRIORITY/CROSS-REFERENCE TO RELATED APPLICATION

The present application is based on and a claim of priority is made under 35 U.S.C. § 119 (e) to U.S. Provisional Patent Application No. 63/684,825, filed on Aug. 19, 2024, the contents of which are incorporated herein in their entirety by reference.

### FIELD OF THE INVENTION

The present invention is generally directed to systems and methods for generating hydrogen through serpentinization of iron-bearing rock, or otherwise rock containing iron, including but not limited to mafic rock, ultramafic rock, banded iron formations, etc., and more specifically to systems and methods that accelerate the production of hydrogen through the use of one or more of the following: (a) geothermally heated fluids, (b) surface heated fluids, (c) water-based chemically-treated waterflood, and/or (d) a fluidically circulating system through the use of a plurality of hydraulically and/or fluidically communicative wellbores. Furthermore, in some cases, recovery of produced steam or other energy can be used to produce geothermal power.

### BACKGROUND OF THE INVENTION

The energy transition from carbon dioxide emitting fuels to clean sources of energy has accelerated in the recent years with support from local and federal governments, private business and society in general. Several technologies have been identified as an alternative energy source to facilitate the transition, including hydrogen, since hydrogen has high energy density by mass and produces water as the only combustion byproduct.

While hydrogen is intrinsically a clean fuel, some processes used to generate hydrogen are carbon intensive, requiring the use of hydrocarbons as a precursor material.

Other hydrogen generation technologies or processes use or leverage electrolysis, or other like methods, which require high amounts of energy consumption.

However, several geological processes, such as deep crustal sources, radiolysis and serpentinization, can be used to produce hydrogen without carbon emissions and without using large quantities of energy.

More specifically, serpentinization is a geological process where iron-bearing rocks and/or rocks containing or comprising any amount of iron, including for example, igneous rocks, mafic rocks, ultramafic rocks, banded iron formations, etc. react with water to produce one or more secondary minerals and hydrogen. The reaction kinematics are dependent on multiple factors, including but not limited to, temperature, fluid chemistry, grain size, minerology and the presence of catalysts. While the serpentinization reaction occurs naturally, the rate of hydrogen production through serpentinization at in situ conditions is slow and not sufficient for commercial production or applications.

Accordingly, there is a need for systems and methods that effectively accelerate the production, generation and/or collection of hydrogen from serpentinization of a rock formation or layer, such as, for example, iron-bearing rocks, iron-rich rocks, and/or rocks containing or comprising any amount of iron, including but not limited to igneous rocks, mafic rocks, ultramafic rocks, and/or banded iron formations.

The proposed systems and methods of at least one embodiment utilize circulation techniques that are formed through a plurality of wellbores disposed in a fluidic or hydraulic communication with one another in the serpentinizing rock formation, igneous rock and/or iron-rich rock layer. Other proposed features of some embodiments include the use of geothermal techniques through the formation of at least one, although in some cases a plurality of deep wellbores that extend to a geothermal rock layer to provide heat to a fluid flowing therethrough. That heated fluid can then be deposited or injected directly into the targeted rock layer, including an igneous rock layer, a mafic rock layer, and/or an ultramafic rock layer, or produced to the surface and reinjected into the mafic or ultramafic rock layer, to further enhance or accelerate the production of hydrogen through the serpentinization therein.

Heated fluids produced to or near the surface and separated from hydrogen may be re-injected back into the targeted rocks, e.g., the mafic or ultramafic rocks, to produce more hydrogen or used to generate electricity, for example, through one or more turbines, co-generation systems, heat recovery units or in direct-use heating applications.

### SUMMARY OF THE INVENTION

Accordingly, the present invention is generally directed to systems and methods for generating hydrogen through serpentinization of iron-bearing rocks, iron-rich rocks, and/or rocks, rock formation or rock layers containing or comprising any amount of iron, including for example, mafic rocks, ultramafic rocks, banded iron formations, etc. It should be noted that, for purposes of clarity and simplicity, the term “iron-bearing rocks,” as used herein, shall include any rocks, rock formations, or rock layers that include, comprise or contain any amount of iron, iron compounds and/or iron minerals (e.g., iron oxides, sulfides, carbonates, hematite, magnetite, geothite, limonite, siderite, etc.), whether large amounts or small amounts, and can include, but are in no way limited to mafic rocks, ultramafic rocks, banded iron formations (BIFs), ironstones, iron ores, olivine, etc. Moreover, in some cases, the iron-bearing rocks can include an amount of iron III phase, iron II phase, or ferrous iron II phase. Furthermore, in some instances, the terms “targeted rock,” “targeted formation” or “targeted layer,” whether in the plural or singular form, may be used to refer to any iron-bearing rock, formation or layer.

For instance, in addition to secondary minerals, serpentinization of a targeted rock can, in many cases, produce molecular hydrogen (H₂) which is generated through oxidation of ferrous iron II phase (Fe(II)) released from the dissolving rock (e.g., olivine) to ferric iron III phase (Fe(III)) that precipitates in serpentine and magnetite. This can be written as: 2[Fe(II)O]+H₂O→[Fe(III)₂O₃]+H₂, where [Fe(II)O] is the ferrous Fe derived from the rock (e.g., olivine) and [Fe(III)₂O₃] is the ferric component of serpentine and magnetite. It should also be noted that the amount of hydrogen generated during serpentinization can be dependent on how the iron is partitioned among the reaction products or targeted rock.

More specifically, some embodiments of the present invention are directed to systems and methods that accelerate the production of hydrogen through the creation of a circulating system with the use of at least one, although in some embodiments, a plurality of hydraulically or fluidically communicative wellbores. At least one of the wellbores may be formed in the targeted rock layer (e.g., a rock layer or formation that includes iron-bearing rock, rock containing any amount of iron, etc. including, for example, mafic rock, ultramafic rock, BIFs, etc.) In some embodiments, the systems and methods include one or more geothermal heating systems or one or more wellbores formed in geothermal rock layer to ultimately provide heat to the targeted rock layer.

It should be noted that, as disclosed herein, some embodiments may introduce heat into the targeted rock layer through surface heating instead of or in addition to the geothermal heating system.

In particular, at least one embodiment of the present invention includes the creation or the formation of at least one, although in many cases, a plurality of wellbores that are fluidically or hydraulically communicative or interconnected with one another to form a circulation of fluid that enhances and accelerates the production of hydrogen through the serpentinization process. For example, in at least one embodiment, one or more deep-injector or geothermal-injector wellbores are formed into a rock formation that geothermally heats water-based fluids pumped therethrough. One or more heat-transfer or geothermal-collection wellbores are fluidically or hydraulically communicative with the deep-injector or geothermal-injector wellbores to collect the geothermally-heated fluid pumped there through.

In at least one embodiment, the one or more heat-transfer wellbores or geothermal-collection wellbores is/are also fluidically or hydraulically communicative with a targeted rock layer, including, for example, an iron-bearing rock formation or layer, which allows the geothermally-heated fluid to flow directly into the targeted rock layer, without first travelling to the surface. More specifically, in such an embodiment, the geothermally-heated fluid is pumped or injected into the mafic, ultramafic or other targeted rock, layer or formation directly from the heat-transfer or geothermal-collection wellbore(s) prior to reaching the surface-a feature that conserves the heat and/or energy by being directly deposited from the geothermal reservoir or layer to the targeted rock layer, resulting in more efficient heating.

In other embodiments, the geothermally-heated fluid may be collected at or transferred to the surface or near the surface, where it is then injected or pumped into the targeted rock layer, e.g., the iron-bearing rock layer, via another wellbore, such as a shallow-injector or serpentinization-injector wellbore. In some cases, the geothermally-heated fluid may be chemically treated and/or heated prior to being injected or pumped into the iron-bearing or iron-rich rock layer, although in other cases, the geothermally-heated fluid may be injected or pumped into the iron-bearing rock layer without further heating or chemical treatment.

Furthermore, one or more producer wellbores are also used to collect the serpentinization byproduct, water-based fluid and/or hydrogen gas after the fluid is circulated through the iron-bearing or iron-rich rock layer, e.g., the mafic and/or ultramafic rock layer. In some cases, fluids collected from the heat-transfer or geothermal-collection wellbore(s) and/or the producer wellbore(s) are re-integrated or re-injected into the system through either one or both of the serpentinization-injector wellbore(s) and/or the geothermal-injector wellbore(s).

Moreover, in some embodiments, the one or more shallow-injector or serpentinization-injector wellbore(s) may also be used to pump chemically-treated and/or surface-heated water-based fluid into the targeted rock layer, such as the iron-bearing or iron-rich rock layer, e.g., the mafic and/or ultramafic rock layer, to further accelerate the serpentinization reaction by controlling the water chemistry and rock temperature.

Specifically, in at least one embodiment, the water-based fluids are injected into the targeted rock, via the shallow-injector or serpentinization-injector wellbore(s) following treatment, for example, at or by a surface treatment facility, to control characteristics of the water-based fluid, including but in no way limited to the pH of the fluid, the total dissolved solids (TDS) of the fluid, chemical stimulants, and catalysts.

For example, the pH of the water-based fluids may be controlled through the addition or removal of acids or bases, buffer solutions or other chemicals in the surface treatment facility in a single step, multiple steps or continuous process. An automated pH control system may be utilized within the surface treatment facility to allow the continuous monitoring and alteration of the pH to suit operational requirements. Use of acids and bases can be tailored to conform with ore geochemistry and the subsurface conditions.

Serpentinization usually produces alkaline fluids with high pH levels-usually greater than pH 9. Acids may be used to re-condition and lower the fluid pH following the serpentinization reaction.

Other reactions may form acidic conditions. For example, if carbon dioxide is present, it can form carbonic acid leading to lower pH fluids. Bases may be added to re-condition the fluid to raise the pH level following the reaction.

As just an example, the pH level of the water-based fluid injected or pumped into the targeted rock layer and/or iron-bearing or iron-rich rock, e.g., mafic or ultramafic rock, via the shallow-injector or serpentinization-injector wellbore(s) may be between pH 3-13, depending on several factors, including for example, which processes are dominant and how much the fluid is re-conditioned prior to re-injection, although other ranges and/or ranges less than pH 3 and/or higher than pH 13 may be included within the scope of the present invention.

Moreover, water total dissolved solids (TDS) may be an important factor in the amount of hydrogen produced from serpentinization. For example, generally lower TDS water-based fluids will result in increased hydrogen production.

Some methods of controlling the TDS in the fluid can include: surface-treatment processes such as membrane filtration (e.g., reverse osmosis, nanofiltration, etc.), electrodialysis, distillation, ion exchange, mixing with other fluids (dilution), etc., or chemical methods such as precipitation using chemical coagulation and flocculation, electrochemical precipitation, etc. Should the TDS need to be raised, this can be achieved, for example, by the addition of salts or brines containing salts such as sodium chloride.

Catalysts aim to improve the serpentinization reaction rate by lowering the activation energy. Catalysts may be added to or removed from the water-based fluids in the surface treatment facility in a single step, multiple steps or as part of a continuous process. An automated catalyst control system may be utilized within the surface treatment facility to allow the continuous monitoring and alteration of the water-based fluid's catalyst content to suit operational requirements. In some embodiments, in addition to or instead of adding one or more catalysts to the water or fluid, one or more catalysts can be provided through a coating on a proppant that is pumped, injected or otherwise delivered into one or more of the wellbores described herein. More specifically, the catalyst(s) can be combined with a proppant (e.g., by coating the proppant with the catalyst(s) or otherwise attaching the catalyst(s) to the proppant). Then, the catalyst-coated proppant can be injected, pumped or otherwise delivered within the one or more wellbores (e.g., to the targeted rock layer or other layer) where the catalyst(s) will remain and be available to mix with a fluid.

The catalysts as used in connection with at least one embodiment of the present invention can include, but are in no way limited to, metal ion catalysts (including transition metals such as platinum and nickel), spinel group minerals (such as chromite) and other minerals.

Furthermore, chemical stimulants may include, but are not limited to, organic acids which help to break down the minerals, carbon dioxide which can cause swelling of the targeted rock and/or iron-bearing rock, and initiate fractures, foaming agents which can act as a carrier for hydrogen gas molecules to assist with collecting them from reaction surfaces, etc.

Moreover, as described herein in connection with several embodiments, the temperature of the water-based fluid can be controlled by either heating the fluid at the surface and/or circulating the fluid through geothermally-heated subsurface rock formations, or a combination of these or other methods. Surface heating methods may include, but are not limited to, waste heat, waste steam, renewable energy generated heat, the use of produced or excess hydrocarbons, etc.

An automated system may be used to monitor and control the temperature of the water-based fluid to ensure that the water-based fluid is injected into the iron-bearing or iron-rich rocks at temperatures between approximately fifty degrees Celsius (50° C.) to approximately five hundred degrees Celsius (500° C.).

Hydraulic and/or other fractures may be created within or extending from the various wellbores in order to create or enhance a fluidic and/or hydraulic communication there between, as described herein.

### BRIEF DESCRIPTION OF DRAWINGS

FIG. 1A is a schematic representation of a system for generating hydrogen through serpentinization of iron-bearing rock and/or rock containing an amount of iron, as disclosed in at least one embodiment of the present invention.

FIG. 1B is a high-level flow chart illustrating a method for generating hydrogen through serpentinization of iron-bearing rock and/or rock containing an amount of iron, as disclosed in at least one embodiment of the present invention.

FIG. 1C is a high-level flow chart illustrating another method for generating hydrogen through serpentinization of iron-bearing rock and/or rock containing an amount of iron, as disclosed in at least one embodiment of the present invention.

FIG. 2A is a schematic representation of another system for generating hydrogen through serpentinization of iron-bearing rock and/or rock containing an amount of iron, as disclosed in at least one embodiment of the present invention.

FIG. 2B is a high-level flow chart illustrating a method for generating hydrogen through serpentinization of iron-bearing rock and/or rock containing an amount of iron, as disclosed in at least one embodiment of the present invention.

FIG. 3A is a schematic representation of another system for generating hydrogen through serpentinization of iron-bearing rock and/or rock containing an amount of iron, as disclosed in at least one embodiment of the present invention.

FIG. 3B is a schematic representation of yet another system for generating hydrogen through serpentinization of iron-bearing rock and/or rock containing an amount of iron, as disclosed in at least one embodiment of the present invention.

FIG. 3C is a high-level flow chart illustrating a method for generating hydrogen through serpentinization of iron-bearing rock and/or rock containing an amount of iron, as disclosed in at least one embodiment of the present invention.

FIG. 4A is schematic representation of a system for generating hydrogen through serpentinization of mined iron-bearing rock and/or rock containing an amount of iron, as disclosed in at least one embodiment of the present invention.

FIG. 4B a high-level flow chart illustrating a method for generating hydrogen through serpentinization of mined iron-bearing rock and/or rock containing an amount of iron, as disclosed in at least one embodiment of the present invention.

Like reference numerals refer to like parts throughout the several views of the drawings provided herein.

### DETAILED DESCRIPTION OF THE INVENTION

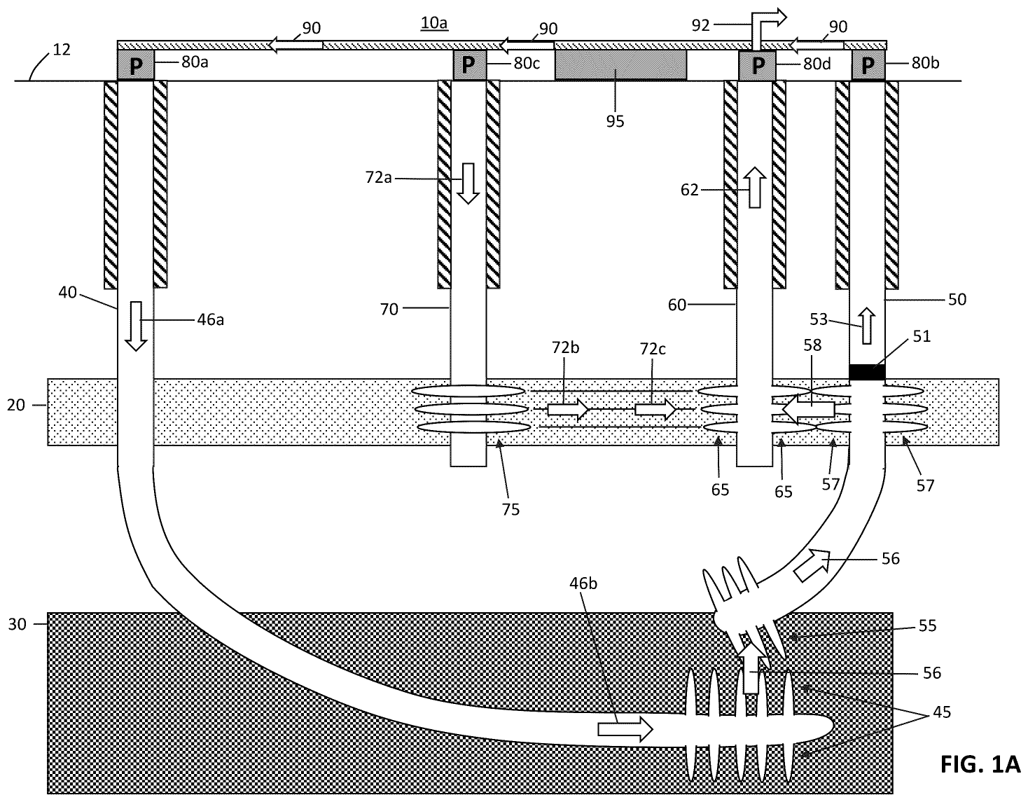

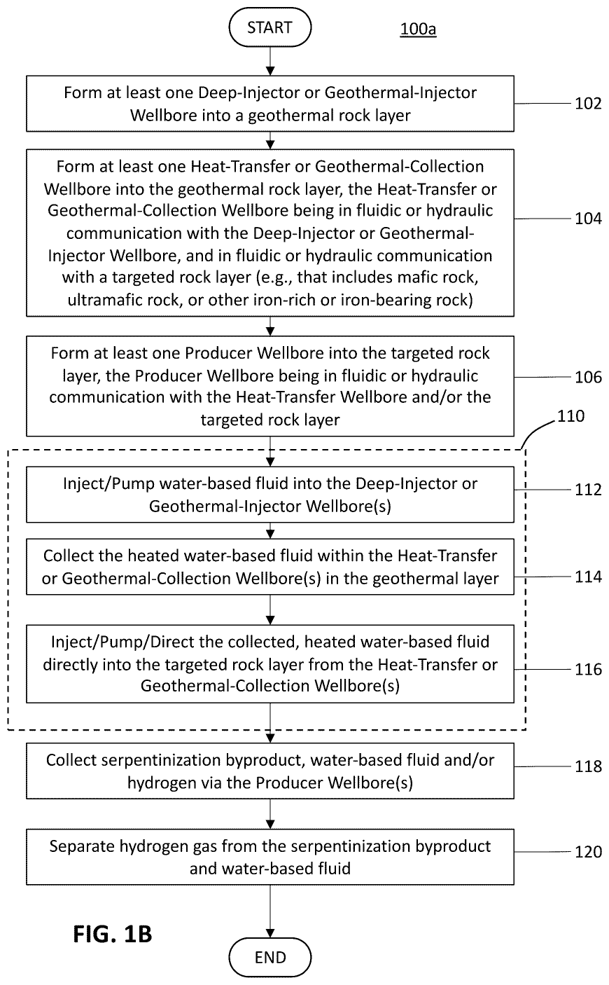

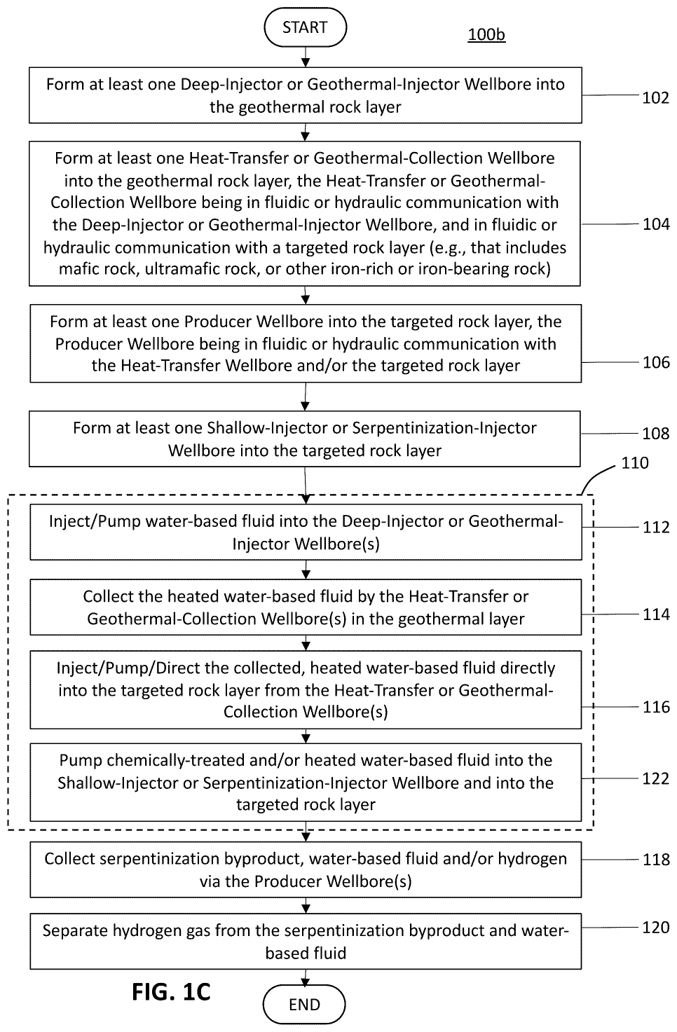

As shown in the accompanying drawings, and with particular reference to FIG. 1A, 2A, 3A and 3B, at least one embodiment of the present invention is directed to a system 10a-10d for accelerating the production of hydrogen through serpentinization of a rock layer 20. As described in accordance with at least one embodiment, herein, the rock layer 20, within which the serpentinization process occurs, is sometimes referred to as a targeted rock layer and is an iron-bearing or iron-rich rock layer, including, for example, a mafic rock formation or layer and/or an ultramafic rock formation or layer, although other rock formations, in addition to or instead of the mafic and/or ultramafic rock formations, may exist in the targeted rock layer 20. In particular, as provided above, the term “iron-bearing rocks,” as used herein, shall include any rocks, rock formations, or rock layers that include, comprise or contain any amount of iron, iron compounds and/or iron minerals (e.g., iron oxides, sulfides, carbonates, hematite, magnetite, geothite, limonite, siderite, etc.), whether large amounts or small amounts, and can include, but are in no way limited to mafic rocks, ultramafic rocks, banded iron formations (BIFs), ironstones, iron ores, etc. Furthermore, in some instances, the terms “targeted rock,” “targeted formation” or “targeted layer,” whether in the plural or singular form, may be used to refer to any iron-bearing rock, formation or layer.

Furthermore, as described herein, and with reference to FIGS. 1B, 1C, 2B, 3C, other embodiments of the present invention are directed to methods 100a-100d for accelerating the production of hydrogen through serpentinization of the targeted rock formation or layer 20.

More specifically, in at least one embodiment, and with reference to FIGS. 1A and 1B, one or more deep-injector wellbore(s) or geothermal-injector wellbore(s) 40 may be formed or created that extend into a geothermal rock layer and/or a stratigraphic layer 30, as generally referenced 102 in FIG. 1B. The geothermal rock and/or stratigraphic layer 30 of at least one embodiment provides geothermal heat, as described herein, and can therefore include a formation temperature of between approximately fifty degrees Celsius (50° C.) to approximately five hundred degrees Celsius (500° C.). It should be noted, however, that the formation temperature of the geothermal rock layer and/or stratigraphic layer 30 may be below 50° C. and/or above 500° C. and still produce geothermal heat and may still, therefore, fall within the full spirit and scope of the present invention.

As just an example, the top end of the geothermal rock layer and/or stratigraphic layer 30 may be between approximately 3,000 feet to approximately 7,000 feet, whereas the bottom end of the geothermal rock layer and/or stratigraphic layer 30 may be between 14,000 feet and 18,500 feet. Of course, other shallower or deeper depths of the geothermal rock layer and/or stratigraphic layer 30 are contemplated, are subject to geological uncertainty and are within the full spirit and scope of the various embodiments of the present invention. In other words, the depths provided herein are exemplary and should not be considered limiting in any manner. As an example, local high temperature anomalies or situations may provide geothermal heat at shallow depths, such as via intrusive bodies or volcanism.

Moreover, the deep-injector or geothermal-injector wellbore(s) 40 may, therefore, extend from a ground surface, represented as 12, down into the geothermal rock layer and/or a stratigraphic layer 30. In some cases, the deep-injector or geothermal-injector wellbore(s) 40 is/are fractured such that a plurality of fractures, e.g., breaks, cracks, ruptures or fissures, represented as 45, are formed within, at least partially within or extend from the wellbore 40. In the embodiment illustrated in FIG. 1A, the fractures 45 of the deep-injector or geothermal-injector wellbore(s) 40 are shown at the distal end or deep-end of the wellbore 40, although in other embodiments, the fractures 45 may extend from other locations of the wellbore 40.

It should be noted that the fractures 45 may be formed through hydraulic fracturing, e.g., by pumping water-based fluid(s) into the wellbore 40 at pressures high enough to either create new fractures or to re-activate existing or previously created fractures. Other fracturing methods or processes, however, may be implemented in the various embodiments described herein.

Still referring to FIGS. 1A and 1B, in at least one embodiment, one or more heat-transfer wellbore(s) or geothermal-collection wellbore(s) 50 may also be formed or created that extend into the geothermal rock layer and/or a stratigraphic layer 30, as generally referenced as 104 in FIG. 1B. The heat-transfer or geothermal-collection wellbore(s) 50 is/are in direct or indirect fluidic or hydraulic communication with the deep-injector or geothermal-injector wellbore 40, such that fluid may flow from the injector wellbore 40 and into the heat-transfer or geothermal-collection wellbore 50. For instance, in some cases, the heat-transfer or geothermal-collection wellbore(s) 50 is/are fractured such that a plurality of fractures, e.g., breaks, cracks, ruptures or fissures, represented as 55, are formed within, at least partially within or extend from the wellbore 50.

More specifically, the heat-transfer or geothermal-collection wellbore(s) 50, of at least one embodiment, may therefore extend from a ground surface 12 down into the geothermal rock layer and/or a stratigraphic layer 30. In the embodiment illustrated in FIG. 1A, at least some of the fractures 55 are shown at the distal end of the wellbore 50, although in other embodiments, the fractures 55 may extend from other locations of the wellbore 50.

In this manner, the fluidic or hydraulic communication between the deep-injector or geothermal-injector wellbore 40 and the heat-transfer or geothermal collection wellbore 50 may be accomplished through fluidic or hydraulic communication with fractures 45, 55 as shown in FIG. 1A.

Furthermore, in the embodiment illustrated in FIG. 1A, the heat-transfer or geothermal-collection wellbore(s) 50 also extend into or are otherwise fluidically or hydraulically communicative with the targeted rock layer 20, including, for example, the iron-bearing and/or iron-rich rock layer, that may but need not necessarily include at least one of mafic rock and/or ultramafic rock. In some embodiments, one or a plurality of fractures 57 are also formed along the heat-transfer or geothermal-collection wellbore 50 within the targeted rock layer 20. As will be described herein, these fractures 57 within or communicative with the targeted rock layer 20, e.g., the mafic and/or ultramafic rock layer, allow the heat-transfer or geothermal collection wellbore(s) 50 to be in a fluidic or hydraulic communication with the targeted rock layer 20 and/or other wellbores 60, 70 formed therein as described below.

For instance, still referring to FIGS. 1A and 1B, in at least one embodiment, one or more producer wellbore(s) 60 may also be formed or created that extend into the targeted rock layer 20, e.g., the mafic and/or ultramafic rock layer, as generally referenced as 106 in FIG. 1B. The producer wellbore(s) 60 is/are in fluidic or hydraulic communication with the targeted rock layer 20, e.g., the mafic and/or ultramafic rock layer, and/or the heat-transfer or geothermal-collection wellbore 50, such that fluid may flow from the heat-transfer or geothermal-collection wellbore 50, through the targeted rock layer 20, and into the producer wellbore 60. For instance, in some cases, the producer wellbore(s) 60 is/are fractured such that a plurality of fractures, e.g., breaks, cracks, ruptures or fissures, represented as 65, are formed within, at least partially within, or extend from the wellbore 60.

More specifically, the producer wellbore(s) 60, of at least one embodiment, may therefore extend from the ground surface 12, and down into the targeted rock layer 20. In the embodiment illustrated in FIG. 1A, at least some of the fractures 65 are shown at or near the distal end of the producer wellbore 60, although in other embodiments, the fractures 65 may extend from other locations of the wellbore 60.

In this manner, the fluidic or hydraulic communication between the producer wellbore 60 and the heat-transfer or geothermal-collection wellbore 50 may be accomplished through fluidic or hydraulic communication with fractures 57, 65, as shown in FIG. 1A.

As shown at 110 in FIG. 1B, the method 100a of at least one embodiment includes heating or raising the temperature of the targeted rock formation 20, e.g., the mafic and/or ultramafic rock layer. In at least one embodiment, this may be accomplished with geothermally-heated fluid, although as described in accordance with other embodiments, other processes may be used instead of or in addition to geothermal heat. More specifically, in at least one embodiment, the method 100a includes injecting or pumping a water-based fluid into the deep-injector or geothermal-injector wellbore(s) 40 that are formed into the geothermal rock layer 30, as shown at 112. One or more pumps 80a may be used to pump the water-based fluid down into and/or through the deep-injector or geothermal-injector wellbore 40. Although the pump 80a is shown at the surface 12, other locations of the pump 80a are contemplated, including beneath the surface 12 and/or within the wellbore 40.

In particular, as generally shown at arrows 46a, 46b in FIG. 1A, the fluid will travel from the surface 12 through the deep-injector or geothermal-injector wellbore(s) 40 drilled or formed at any deviation, and through fractures 45 in the geothermal formation 30. The fluid is heated from the rock(s) in the geothermal formation or layer 30 as it travels through the wellbore(s) 40, the fracture(s) 45, and the rock formation or layer 30.

The heated fluid is collected via the heat-transfer or geothermal-collection wellbore(s) 50 by flowing into the heat-transfer or geothermal-collection wellbore 50 from within the deep or geothermal rock formation or layer 30, as shown at arrow 56. For instance, in some cases, the fluid will flow through the fractures 45, 55 and into the heat-transfer or geothermal-collection wellbore(s) 50. One or more pumps 80b may be used to pump the fluid up into and/or through the heat-transfer or geothermal-collection wellbore 50. Although the pump 80b is shown at the surface 12, other locations of the pump 80b are contemplated, including beneath the surface 12 and/or within the wellbore 50.

For instance, the collected and heated fluid will flow up through the heat-transfer or geothermal-collection wellbore 50, as shown by arrow 56 and as represented at 114 in FIG. 1B. In at least one embodiment, as shown in FIG. 1A, at least some of the geothermally-heated fluid will flow or be injected or pumped into the targeted rock layer 20, e.g., the mafic and/or ultramafic rock layer, as shown by arrow 58 and as represented as 116 in FIG. 1B. For instance, in some embodiments, fractures 57 formed in the targeted rock layer 20 allow the collected and heated fluid to flow directly into the rock layer 20 from the heat-transfer or geothermal-collection wellbore(s) 50.

In some embodiments, a valve 51 may be included or installed within the heat-transfer or geothermal-collection wellbore 50 which can be controlled, e.g., opened and/or closed, to further facilitate or control the flow of the collected and heated fluid. For instance, the valve 51 can be closed to direct the collected, heated fluid directly into the targeted rock layer, or the valve 51 can be opened to allow some or all of the collected, heated fluid to flow to the surface, for example, as shown by arrow 53. This can be used to manage or control the pressure of the fluid flowing into the targeted rock layer 20.

In any event, the heated fluid causes the rocks in the targeted rock layer 20, such as the mafic and/or ultramafic rocks, to heat and generate a serpentinization byproduct, such as hydrogen gas. The byproduct, hydrogen gas, and/or water-based fluid is then collected via the producer wellbore(s) 60, as shown by arrow 62 in FIG. 1A and as represented by 118 in FIG. 1B. The hydrogen gas may be separated from the byproduct at the surface of the producer wellbore(s) 60 and/or downhole, e.g., within the producer wellbore(s) 60 via membrane or other process, as represented at 120.

With reference now to FIGS. 1A and 1C, another feature of at least one embodiment of the present invention includes pumping or injecting fluid directly into the rock layer 20, e.g., the mafic and/or ultramafic rock layer, through a shallow-injector or serpentinization-injector wellbore 70.

For example, still referring to FIGS. 1A and 1C, in at least one embodiment, one or more shallow-injector or serpentinization-injector wellbore(s) 70 may be formed or created that extend into the targeted rock layer 20, as generally referenced as 108 in FIG. 1C. As just an example, the top end of the targeted rock layer 20 may be between approximately 0 feet (surface) to approximately 5,000 feet, whereas the bottom or base end of the mafic or ultramafic layer 20 may be between 4,000 feet and 10,000 feet. Of course, other shallower or deeper depths of the targeted rock layer 20 are contemplated, are subject to geological uncertainty and are within the full spirit and scope of the various embodiments of the present invention. In other words, the depths provided herein are exemplary and should not be considered limiting in any manner.

It should also be noted that while in FIG. 1A, for example, the geothermal layer 30 is shown as being deeper than the targeted rock layer 20, in some cases, there may be a geothermal heat source or layer 30 that is shallower than or lateral to the targeted rock layer 20. In this manner, the relative depths of the targeted rock layer 20, the mafic, ultramafic or other rocks in the targeted rock layer 20, and the geothermal layer 30 shown in FIG. 1A, for example, is exemplary and should not be considered limiting in any manner.

Furthermore, the shallow-injector or serpentinization-injector wellbore(s) 70 of at least one embodiment is/are in fluidic or hydraulic communication with the targeted rock layer 20, e.g., the mafic and/or ultramafic rock layer, and/or the producer wellbore(s) 60, such that fluid may be pumped into the shallow-injector or serpentinization-injector wellbore(s) 70, as shown at 122 in FIG. 1C, flow from the shallow-injector or serpentinization-injector wellbore(s) 70 through the targeted rock layer 20, and into the producer wellbore(s) 60. For instance, in some cases, the shallow-injector or serpentinization-injector wellbore(s) 70 is/are fractured such that a plurality of fractures, e.g., breaks, cracks, ruptures or fissures, represented as 75, are formed within, at least partially within, or extend from the wellbore(s) 70 and into the targeted rock layer 20.

More specifically, the shallow-injector or serpentinization-injector wellbore(s) 70, of at least one embodiment, may therefore extend from the ground surface 12, down into the targeted rock layer 20, e.g., that includes mafic and/or ultramafic rock. In the embodiment illustrated in FIG. 1A, at least some of the fractures 75 are shown at or near the distal end of the shallow injector wellbore 70, although in other embodiments, the fractures 75 may extend from other locations of the wellbore 70.

In this manner, the fluidic or hydraulic communication between the producer wellbore 60 and the shallow-injector or serpentinization-injector wellbore 70 may be accomplished through fluidic or hydraulic communication with fractures 75, 65, as shown in FIG. 1. One or more pumps 80c may be used to pump the fluid into and/or through the shallow-injector or serpentinization-injector wellbore 70. Although the pump 80c is shown at the surface 12, other locations of the pump 80c are contemplated, including beneath the surface 12 and/or within the wellbore 70.

More in particular, the fluid pumped or injected into the serpentinization-injector wellbore(s) 70 may include a water-based fluid that is chemically treated and/or heated that flows into the rock layer 20, as represented by arrows 72a, 72b, 72c. Chemical treatment of the fluid may include but is in no way limited to the addition of metal ion catalysts (i.e., transition metals such as platinum or nickel), spinel group minerals (such as chromite), organic acids (such as carbon dioxide), and other mineral/organic acids.

The fluid is pumped through or otherwise flows through the targeted rock layer 20, for example, the mafic and/or ultramafic rocks formed therein, which causes the iron-bearing, iron-rich or other like rocks to generate a serpentinization byproduct, such as hydrogen gas. The byproduct, hydrogen gas and/or water-based fluid is then collected in a similar manner, as described above, e.g., via the producer wellbore(s) 60, as shown by arrow 62 in FIG. 1 and as represented by 118 in FIGS. 1B and 1C. One or more pumps 80d may be used to pump the fluid up into and/or through the producer wellbore(s) 60. Although the pump 80d is shown at the surface 12, other locations of the pump 80d are contemplated, including beneath the surface 12 and/or within the wellbore 60.

As before, the hydrogen gas may be separated from the byproduct at the surface of the producer wellbore(s) 60 and/or downhole, e.g., within the producer wellbore(s) 60 via membrane or other process, as represented at 120.

In some cases, the fluid, in some cases having been processed to remove the hydrogen, may be collected from the producer wellbore(s) 60 and/or the heat-transfer or geothermal-collection wellbore(s) 50, and further processed in preparation for re-injection into the shallow-injector or serpentinization-injector wellbore(s) 70, and/or the deep-injector or geothermal-injector wellbore(s) 40, as shown by arrow 90. As described above, the fluid collected from wellbores 50, 60 may be chemically treated and/or heated prior to re-injection or re-introduction through the wellbore(s) 40, 70.

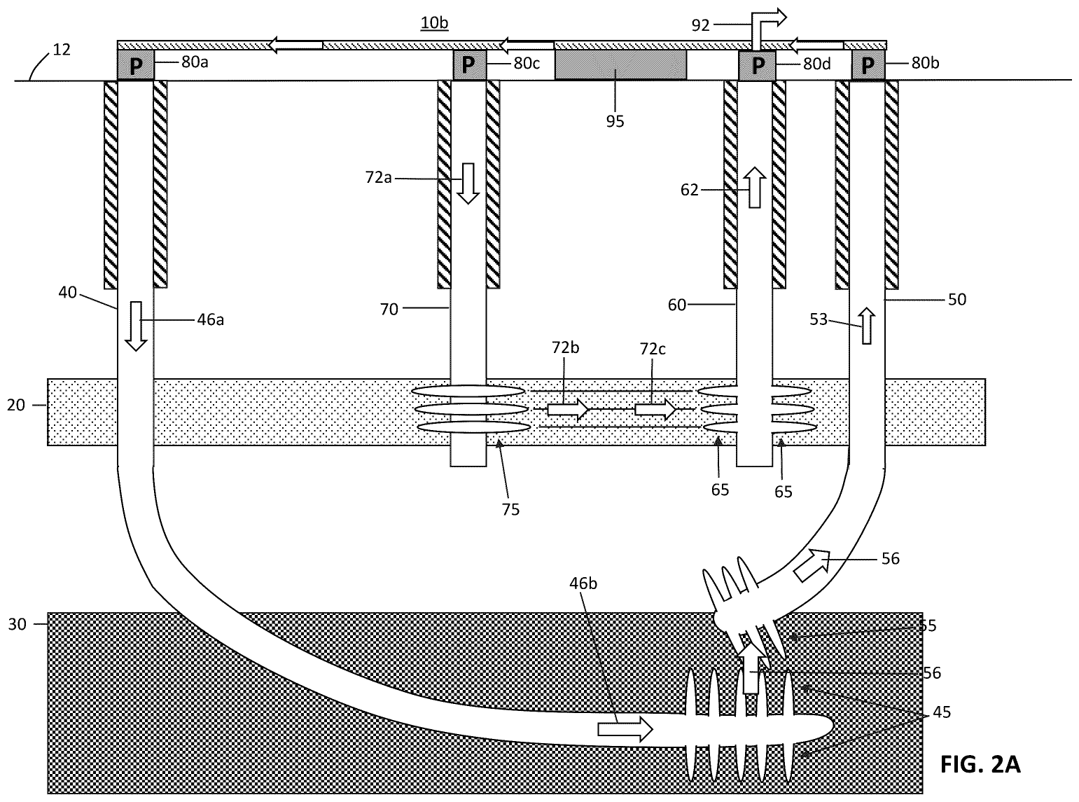

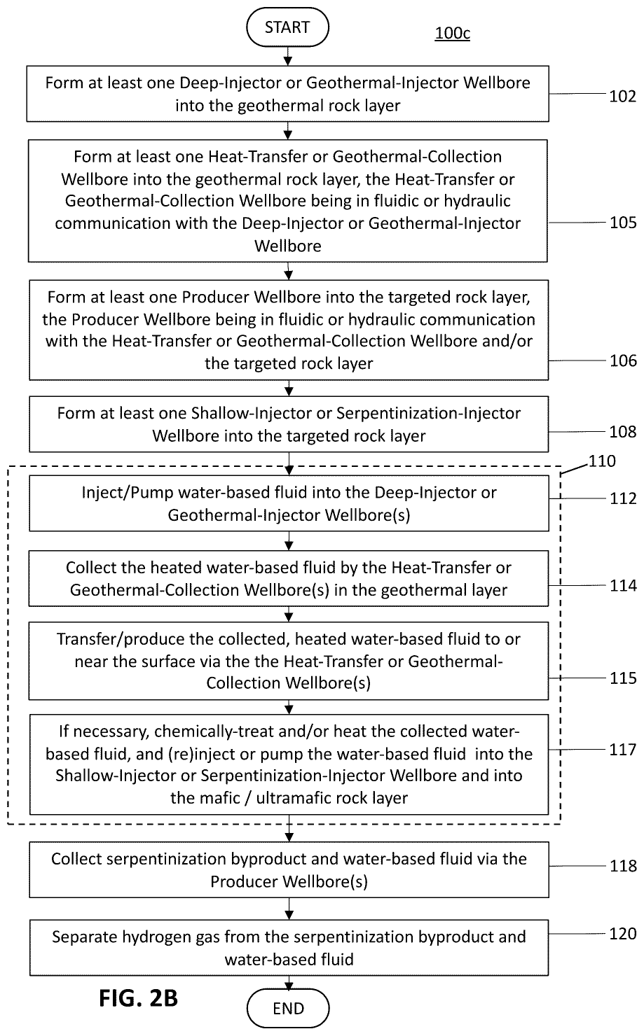

With reference now to FIGS. 2A and 2B, another embodiment shown wherein all of the fluid is collected by the heat-transfer or geothermal-collection wellbore(s) 50 and produced to the surface 12. In particular, as referenced at 105 in FIG. 2B, the heat-transfer or geothermal-collection wellbore 50 is formed into the geothermal layer 30 in hydraulic or fluidic communication with the geothermal-injection wellbore 40. In this embodiment, however, the heat-transfer or geothermal-collection wellbore 50 is not fluidically connected to the targeted layer 20, or otherwise bypasses the targeted layer 20 such that all or substantially all of the heated and collected fluid is produced to the surface as referenced via arrow 53, and as represented at 115 in FIG. 2B.

Once the heated fluid is collected through the heat-transfer or geothermal-collection wellbore 50, for example, at or near the surface or ground level, the fluid may then be prepared for injection or pumping into the system or targeted rock 20 through the shallow-injector or serpentinization-injector wellbore(s) 70. In some cases, the collected, heated fluid from the geothermal-collection wellbore(s) 50 may need to be chemically-treated and/or heated, for example, as described above, although in some cases it may not. As shown at 117 in FIG. 2B, the fluid is then pumped or injected into the shallow-injector or serpentinization-injector wellbore(s) 70 where it flows into the targeted layer 20, that may include mafic and/or ultramafic rock(s), or other iron-rich or iron-bearing rocks.

Furthermore, it should also be noted that the pressure and flow rate of the fluids through any one or both of the geothermal rock layer 30 and the targeted rock layer 20 may be managed by the placement of additional wellbore(s) 40, 50, 60, 70, which are in hydraulic and/or fluidic communication through fractures, reactivation of existing fractures, or naturally occurring fractures.

Additionally, while several embodiments described and depicted herein include one or more fractures, for example, at an end or along the length of one or more of the various wellbores 40, 50, 60, 70, some embodiments or implementations may not need fractures and therefore may not include fractures.

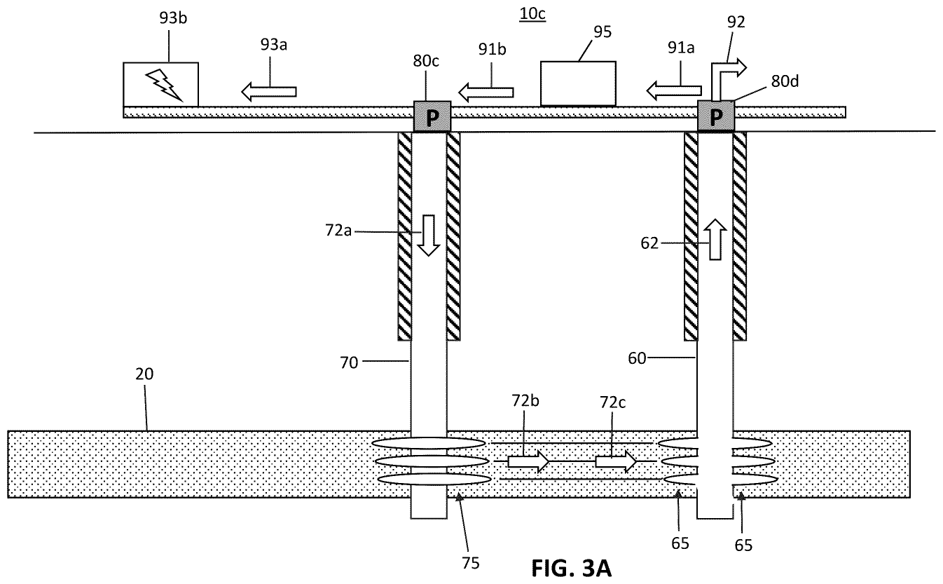

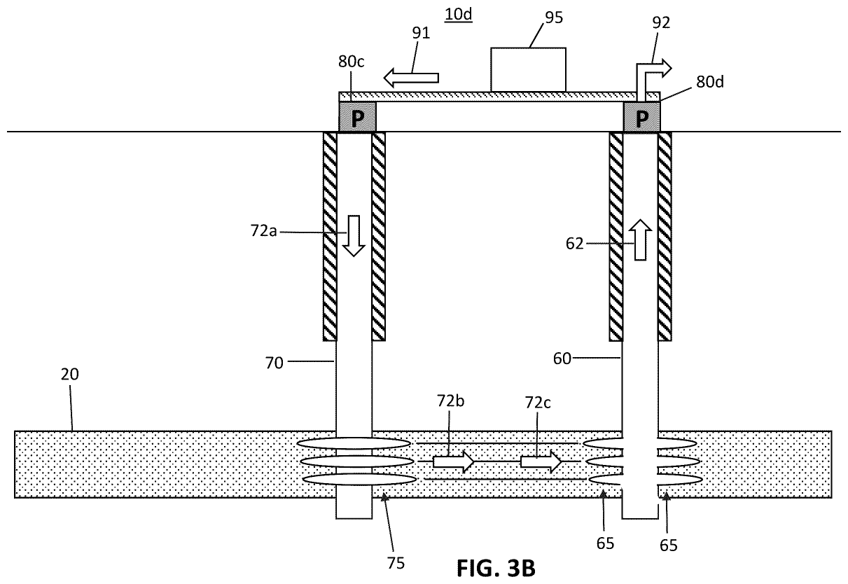

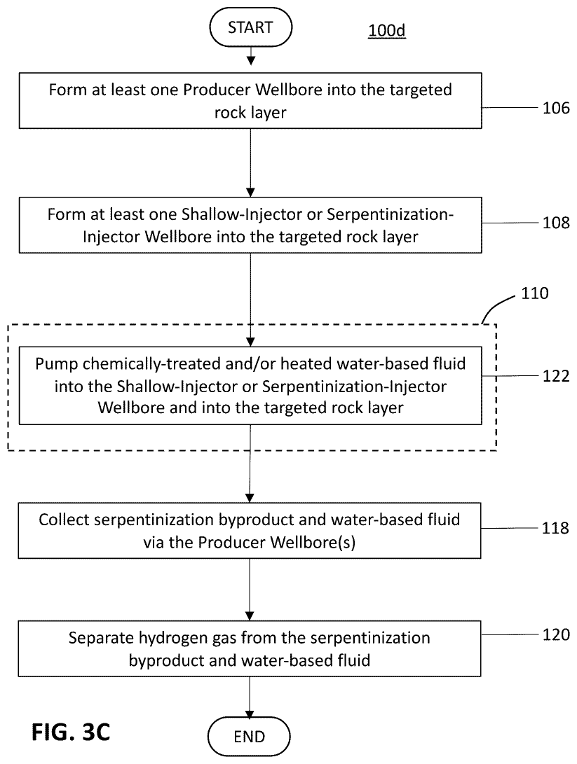

In addition, FIGS. 3A, 3B and 3C represent further embodiments or implementations of the system 10c, 10d and method 100d described herein. Specifically, in these embodiments, the method 100d utilizes the shallow-injector or serpentinization-injector wellbore(s) 70 and the producer wellbore(s) 60 to create a circulation of fluid through the targeted rock layer 20 in order to accelerate the production of hydrogen through the serpentinization process disclosed herein. In some cases, if there is sufficient surface heat or downhole in situ heat, geothermal wellbores may not be needed.

For instance, in FIG. 3A, waterflooding is used to circulate the water-based fluid through the system. In particular, the fluid may flow through the shallow-injector or serpentinization-injector wellbore(s) 70, as represented by arrow 72a, into and through the targeted rock layer 20 and/or the mafic, ultramafic or other iron-bearing or iron-rich rocks, as represented by arrows 72b and 72c, out through the producer wellbore(s) 60, as represented by arrow 62, and introduced or re-introduced into the shallow-injector or serpentinization-injector wellbore(s) 70, as represented by arrows 91a and 91b, after the hydrogen is separated and collected, as shown at 92.

Furthermore, in some cases, waterflooding can be used with surface heat, and in particular, the water-based fluid can be heated at the surface, for example, through geothermally heated fluids, waste heat utilization, waste steam, direct heating or other heating methods or processes, as represented at block 95, in FIG. 3B, and pumped into the targeted rock layer layer 20 using the shallow-injector or serpentinization-injector wellbore(s) 70 to stimulate geological hydrogen production. As just an example, steam, heat or other energy may be captured from a steel mill or other factory, enterprise, petrochemical process, etc. to heat the fluids at or near the surface to then be pumped into the wellbore(s). These fluids may be chemically treated and/or provided with a catalyst at the surface to enhance or accelerate the geological production of hydrogen. Surface-heated water-based fluids may be pumped continually to heat the targeted rock 20, or intermittently to provide alternating hot and cold conditions, or as needed to maintain a specific targeted rock temperature.

Furthermore, as shown in FIG. 3A, at least some of the excess heat, steam or energy from the system 10a-d can be collected as shown at 93a, and/or routed to or used by an external system or device 93b to generate electricity or directly used for heating. In particular, the excess heat, steam or energy may be used to generate electricity, for example, through one or more turbines, co-generation systems, heat recovery units or direct-use applications 93b. It should be noted that while the external energy generation 93a, 93b is shown in the system 10c of FIG. 3A, other embodiments, including the systems 10a, 10b and 10d shown in FIGS. 1A, 2A and 3B can also include the external energy generation 93a, 93b system or devices.

Moreover, the hydraulic fracturing the rock formations or layers, as described herein, may be formed by pumping water-based fluids, or other fluids, downhole at pressures that are high enough to either create new fractures or to reactivate existing fractures. These fractures are used to form a fluidic or hydraulic connection between corresponding wellbores, and to allow for the flow of the fluid and/or gas between wellbores and throughout the rock volume. The hydraulic or other fracturing allows for water-based fluids to be circulated though the rock formations, e.g., the mafic and/or ultramafic rock formations which react to produce hydrogen.

It should also be noted that the term “forming” as used herein, and more specifically, as used in connection with forming a wellbore, such as any of the wellbores 40, 50, 60, 70 described herein, includes creating a new wellbore, reactivating an existing wellbore, or simply using an existing wellbore.

In some implementations, the different components of the present invention, e.g., the wellbores 40, 50, 60, 70, the corresponding fractures, etc. work together to increase the rate of hydrogen production. Geothermally heated fluids are used to raise the temperature of the targeted rocks, e.g., the iron-bearing rock and/or rocks containing an amount of iron, which is achieved through deep-injector or geothermal-injector wellbore(s), which pump water-based fluid into a geothermal formation through fractures. The fluid is heated by being pumped through the geothermal formation, and then captured or collected by one or more separate heat-transfer or geothermal-collection wellbores. The heat-transfer or geothermal-collection wellbore(s) then injects the collected and heated water-based fluid into a targeted rock formation. The fluid circulates through the targeted rock formation, thereby heating the targeted rocks. In particular, to heat a volume of the targeted rocks, the hot fluids circulate through the rock formation (e.g., from the serpentinization-injector wellbore(s) and/or geothermal-collection wellbore(s) to the production wellbore), as needed.

Chemically and/or surface heated water-based fluid, including in some embodiments, surface-heated fluid and/or geothermally-heated fluid produced to the surface, is pumped through the shallow-injector or serpentinization-injector wellbore(s) to further accelerate the reaction by controlling the water chemistry and rock temperature. This fluid is circulated through the targeted rocks and is produced through producer wellbore(s) that are fluidically or hydraulically connected to the shallow-injector or serpentinization-injector wellbore(s), for example, via hydraulic fractures.

It should also be noted that the wellbores 40, 50, 60, 70 of several embodiments described herein can be formed, drilled or created in virtually any trajectory or direction, including vertical, horizontal, angled, deviated, curved, or any combination thereof. In other words, the direction, orientation, angle, curvature, and trajectory of the wellbores 40, 50, 60, 70 illustrated in the Figures are for illustrative purposes only and should not be considered limiting in any manner.

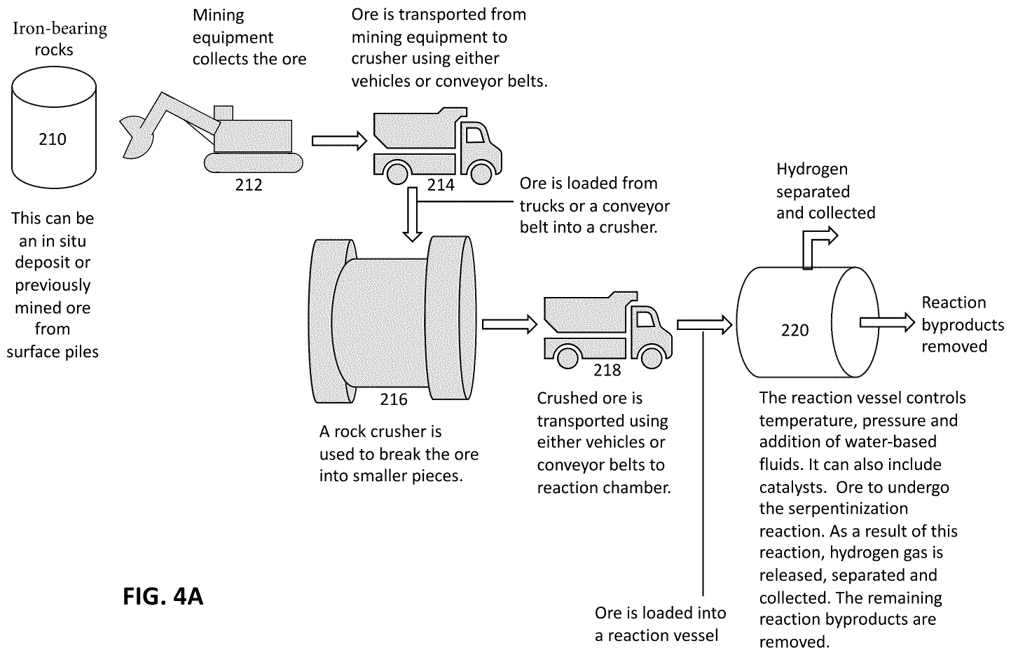

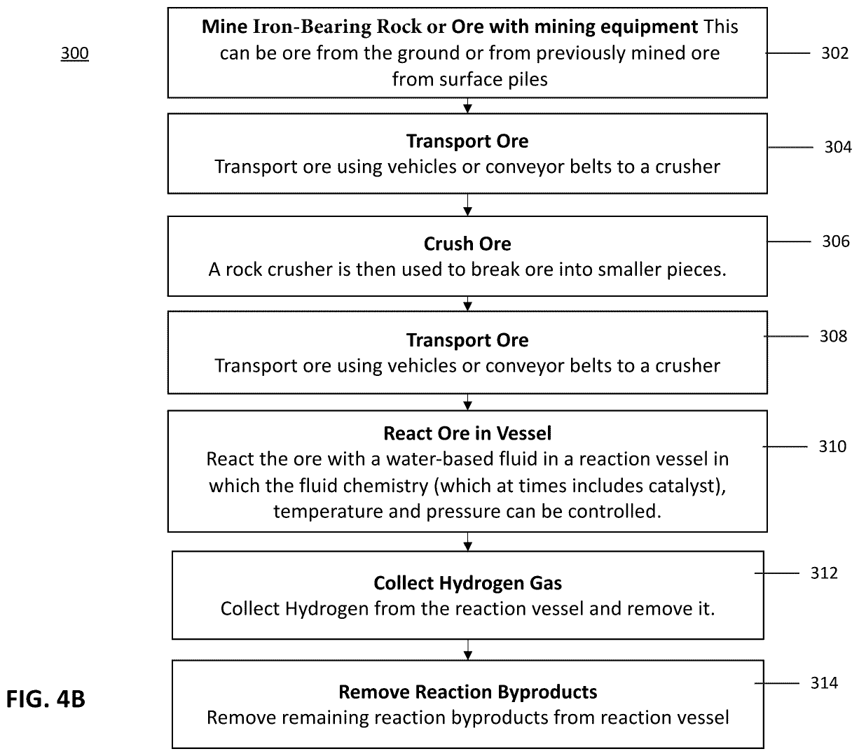

Referring now to FIGS. 4A and 4B, yet another embodiment is illustrated showing systems 200 and methods 300 for the production of hydrogen through mining iron-bearing or iron-rich rocks, such as mafic and/or ultramafic rocks, generally referenced as 210. In particular, the system 200 and method 300 include mining 302 the mafic or ultramafic rocks or ore 210 through the use of mining equipment 212 to collect the ore. The ore 210 may be from the ground, e.g., within subsurface rock bodies, or from previously mined rock material from surface piles.

In some cases, the ore may be transported 304 using one or more vehicles 214, conveyor belts or other like devices, from the mining equipment to a crusher 216. At the crusher 216, the ore is crushed 306 or otherwise broken into smaller pieces. The crushed ore is then transported 308 using vehicles 218, conveyor belts or other devices, to a reaction chamber 220.

At the reaction chamber 220, the ore (e.g., the crushed pieces of mafic or ultramafic rock) reacts 310 with a water-based fluid in which the fluid chemistry, which can in some cases include a catalyst, temperature and pressure are controlled. In the reaction chamber, the ore will undergo a serpentinization reaction. As a result of the serpentinization in the reaction chamber, hydrogen gas is released, separated, and collected 312. The remaining reaction byproducts are then removed 314 from the reaction chamber or vessel. In this manner, the chamber or vessel 220 can be filled with more ore and controlled water-based fluid for another serpentinization reaction.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

1. A method for accelerating the production of hydrogen from serpentinization of a targeted rock layer, the method comprising:
forming at least one geothermal-injector wellbore into a geothermal rock layer, forming at least one geothermal-collection wellbore into the geothermal rock layer, the at least one geothermal-collection wellbore being in fluidic communication with the at least one geothermal-injector wellbore in the geothermal rock layer,
forming at least one producer wellbore into the targeted rock layer, the at least one producer wellbore being in fluidic communication with the at least one geothermal-collection wellbore in the targeted rock layer,
injecting a water-based fluid into the at least one geothermal-injector wellbore to heat the water-based fluid therein,
collecting the heated water-based fluid by the geothermal-collection wellbore disposed in fluidic communication therewith,
injecting the collected, heated water-based fluid into the targeted rock layer from the geothermal-collection wellbore to accelerate serpentinization of the rock in the targeted rock layer,
collecting a serpentinization byproduct through the at least one producer wellbore, and separating hydrogen gas from the serpentinization byproduct.

2. The method as recited in claim 1 further comprising defining the rock in the targeted rock layer as comprising an iron-bearing rock.

3. The method as recited in claim 2 further comprising defining the rock in the targeted rock layer as comprising at least one of: a mafic rock, an ultramafic rock or a banded iron formation.

4. The method as recited in claim 3 further comprising defining the geothermal rock layer as comprising a temperature that is hotter than a temperature of the targeted rock layer.

5. The method as recited in claim 4 wherein the geothermal rock layer comprises a temperature between 50 degrees Celsius and 500 degrees Celsius.

6. The method as recited in claim 1 wherein the at least one geothermal-injector wellbore, the at least one geothermal-collection wellbore, and the at least one producer wellbore create a fluidically interconnected circulating system.

7. The method as recited in claim 6 further comprising forming at least one serpentinization-injector wellbore into the targeted rock layer, the at least one serpentinization-injector wellbore being in fluidic communication with the at least one producer wellbore.

8. The method as recited in claim 7 further comprising injecting a second fluid into the targeted rock layer through the at least one serpentinization-injector wellbore.

9. The method as recited in claim 8 further comprising defining the second fluid as comprising at least one of: a chemically-treated water-based fluid and a heated water-based fluid.

10. A method for accelerating the production of hydrogen from serpentinization of a targeted rock layer, the targeted rock layer comprising iron-bearing rock, the method comprising:
forming at least one geothermal-injector wellbore into a geothermal rock layer,
forming at least one geothermal-collection wellbore into the geothermal rock layer, the at least one geothermal-collection wellbore being in fluidic communication with the at least one geothermal-injector wellbore in the geothermal rock layer,
forming at least one serpentinization-injector wellbore into the targeted rock layer,
forming at least one producer wellbore into the targeted rock layer,
injecting a water-based fluid into the at least one geothermal-injector wellbore to heat the water-based fluid therein,
collecting the heated water-based fluid by the geothermal-collection wellbore disposed in fluidic communication therewith,
injecting the collected, heated water-based fluid into the targeted rock layer to accelerate serpentinization of the rock in the targeted rock layer,
collecting a serpentinization byproduct through the at least one producer wellbore, and
separating hydrogen gas from the serpentinization byproduct.

11. The method as recited in claim 10 further comprising injecting a second fluid into the targeted rock layer through the at least one serpentinization-injector wellbore.

12. The method as recited in claim 11 further comprising defining the second fluid as comprising at least one of: a chemically-treated water-based fluid and a heated water-based fluid.

13. The method as recited in claim 12 wherein said chemically-treated water-based fluid comprises at least one catalyst.

14. The method as recited in claim 10 further comprising coating a proppant with a catalyst and delivering the coated proppant into the targeted rock layer via the at least one serpentinization-injector wellbore.

15. A method for accelerating the production of hydrogen from serpentinization of a targeted rock layer, the targeted rock layer comprising an iron-bearing rock, the method comprising:
forming at least one serpentinization-injector wellbore into the targeted rock layer,
forming at least one producer wellbore into the targeted rock layer, the at least one producer wellbore being in fluidic communication with the at least one serpentinization-injector wellbore in the targeted rock layer,
injecting a fluid into the targeted rock layer through the at least one serpentinization-injector wellbore,
collecting a serpentinization byproduct through the at least one producer wellbore, and
separating hydrogen gas from the serpentinization byproduct.

16. The method as recited in claim 15 further comprising:
forming at least one geothermal-injector wellbore into a geothermal rock layer, and
forming at least one geothermal-collection wellbore into the geothermal rock layer, the at least one geothermal-collection wellbore being in fluidic communication with the at least one geothermal-injector wellbore in the geothermal rock layer.

17. The method as recited in claim 16 further comprising injecting a water-based fluid into the at least one geothermal-injector wellbore to heat the water-based fluid therein.

18. The method as recited in claim 17 further comprising:
collecting the heated water-based fluid by the geothermal-collection wellbore disposed in fluidic communication therewith, and
injecting the collected, heater water-based fluid into the targeted rock layer from the geothermal-collection wellbore to accelerate serpentinization of the rock in the targeted rock layer.

19. The method as recited in claim 15 further comprising coating a proppant with a catalyst and delivering the coated proppant into the targeted rock layer via the at least one serpentinization-injector wellbore.

20. The method as recited in claim 15 further comprising recycling at least a portion of the serpentinization byproduct after separating the hydrogen gas from the serpentinization byproduct.
